(19) United States
(12) Patent Application Publication
(10) Pub. No.: US 2024/0373785 A1
(43) Pub. Date: Nov. 14, 2024

(54) DEVICES, SYSTEMS, AND METHODS FOR PROVIDING YIELD MAPS

(71) Applicant: Ag Leader Technology, Ames, IA (US)

(72) Inventors: Nathan Risius, Huxley, IA (US); Kurt Larsen, Story City, IA (US)

(21) Appl. No.: 18/662,800

(22) Filed: May 13, 2024

Related U.S. Application Data
(60) Provisional application No. 63/466,144, filed on May 12, 2023.

(51) Int. Cl. A01D 41/127; G01S 19/42

(52) U.S. Cl. CPC A01D 41/1271; G01S 19/42

(57) ABSTRACT

A system for mapping yield in real time or near real-time comprising: determining when crop enters a harvester head via one or more sensors; determining when the crop reaches a yield sensor; measuring the time delay between the crop entering the harvester head and when the crop reaches a yield sensor; and adjusting the yield data to account for the time delay.

### CROSS-REFERENCE TO RELATED APPLICATION(S)

This application claims the benefit under 35 U.S.C. § 119 (e) to U.S. Provisional Application 63/466,144, filed May 12, 2023, and entitled Devices, Systems, and Methods for Providing Yield Maps, which is hereby incorporated herein by reference in its entirety for all purposes.

### TECHNICAL FIELD

The disclosure relates to agricultural planting, harvesting, and data analysis.

### BRIEF SUMMARY

Disclosed herein are various systems for improving the accuracy of yield maps.

In Example 1, a method for mapping yield in real time or near real-time comprising determining when crop enters a harvester head via one or more sensors, determining when the crop reaches a yield sensor, and measuring the time delay between the crop entering the harvester head and when the crop reaches a yield sensor.

Example 2 relates to the method of any of Examples 1 and 3-10, further comprising adjusting the yield data to account for the time delay.

Example 3 relates to the method of any of Examples 1-2 and 4-10, further comprising geographically shifting recorded yield values to recorded stalk locations from the one or more sensors based on the time delay.

Example 4 relates to the method of any of Examples 1-3 and 5-10, further comprising measuring a time delay for each pass.

Example 5 relates to the method of any of Examples 1-4 and 6-10, further comprising display time delay adjusted yield maps to an operator on a display.

Example 6 relates to the method of any of Examples 1-5 and 7-10, wherein the one or more sensors are contact sensors.

Example 7 relates to the method of any of Examples 1-6 and 8-10, wherein the one or more sensors are non-contact sensors.

Example 8 relates to the method of any of Examples 1-7 and 9-10, further comprising mapping harvested rows and eliminating reading from the one or more sensors of already harvested rows.

Example 9 relates to the method of any of Examples 1-8 and 10, further comprising determining an actual number of rows being harvested by signals from the one or more sensors and adjusting yield data to come from the actual number of rows being harvested.

Example 10 relates to the method of any of Examples 1-9, further comprising determining ramp up and ramp down periods at the yield monitor and adjusting the yield data to account for ramp up and ramp down periods.

In Example 11, an agricultural harvesting system, comprising at least one sensor disposed on a harvester head configured to detect when crop enter the harvester head, a yield sensor disposed on the harvester configured to measure crop flow, a storage device in communication with the at least one sensor configured to receive signals from the at least one stalk sensor and the yield sensor, and a processor in communication with the at least one storage device configured to processes the signals from the at least one sensor and the yield sensor to determine a harvest delay between when crop is detecting entering the harvester head and when the yield sensor detects crop flow and adjust data from the signals from the at least one sensor and the yield sensor.

Example 12 relates to the system of any of Examples 11 and 13-20, further comprising a display in communication with the storage device and the processor configured to display harvest delay adjusted yield maps to an operator in real time or near real-time.

Example 13 relates to the system of any of Examples 11-12 and 14-20, further comprising a GNSS device configured to determine geographic locations for data from the at least one sensor and the yield sensor, and wherein the processor is further configured to geographically adjust the data from the signals from the at least one sensor and the yield sensor.

Example 14 relates to the system of any of Examples 11-13 and 15-20, wherein the harvest delay is calculated for each harvest pass.

Example 15 relates to the system of any of Examples 11-14 and 16-20, wherein the harvester head is a row crop harvester.

Example 16. relates to the system of any of Examples 11-15 and 17-20, wherein the harvester head is a draper head.

Example 17 relates to the system of any of Examples 11-16 and 18-20, wherein the harvest delay is the time between then the at least one sensor detects crop entering the draper head at a cutting edge and the time when crop flow is detected by the yield sensor.

Example 18 relates to the system of any of Examples 11-17 and 19-20, wherein the at least one sensor is further configured to determine a work width of the draper head.

Example 19 relates to the system of any of Examples 11-18 and 20, wherein the at least one sensor is a non-contact sensor.

Example 20 relates to the system of any of Examples 11-19, wherein the at least one sensor is a contact sensor.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a yield map, according to one implementation.

FIG. 2 is a yield map, according to one implementation.

FIG. 3 is a schematic diagram of a vehicle implementing the system, according to one implementation.

FIG. 4 is a system diagram, according to one implementation.

FIG. 5 is a side view of a harvester implementing the system, according to one implementation.

FIG. 6 is a side view of a harvester implementing the system, according to one implementation.

FIG. 7 is a chart showing stalk sensor and mass flow sensor data across a time period, according to one implementation.

FIG. 8 is a chart showing stalk sensor and mass flow sensor data across a time period, according to one implementation.

FIG. 9 is a chart showing stalk sensor and mass flow sensor data adjusted for a harvest delay across a time period, according to one implementation.

FIG. 10 is a data set of harvest data generated by the system including time, GPS location, stalk count, yield, and corrected yield, according to one implementation.

FIG. 11 is a data set of harvest data generated by the system including time, GPS location, stalk count, yield, and corrected yield, according to one implementation.

FIG. 12 is a perspective view of a draper head implementing the system, according to one implementation.

FIG. 13 is a perspective view of a draper head in use implementing the system, according to one implementation.

FIG. 14 is a top view of a harvester having a vehicle mounted sensor, according to one implementation.

FIG. 15 is a top view of a harvester having header mounted sensor(s), according to one implementation.

### DETAILED DESCRIPTION

Described herein are various systems and associated devices and methods for improving the accuracy of yield maps and data gathered during harvest. By creating and maintaining more accurate maps and data sets, users are able to make better, more informed decisions. The disclosed systems, methods, and devices may reduce time spent in manually or semi-automatically cleaning up maps and data to be more representative of actual conditions.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. patent application Ser. No. 17/060,844, filed Oct. 1, 2020, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,678, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,334, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. Patent Application 63/466,560, filed May 15, 2023, entitled “Devices, Systems, and Methods for Agricultural Guidance and Navigation,” U.S. Patent Application 63/524,065, filed Jun. 29, 2023, entitled “Ring Assembly,” U.S. Patent Application 63/525,525, filed Jul. 7, 2023, entitled “Assisted Steering Systems and Associated Devices and Methods for Agricultural Vehicles,” U.S. Patent Application 63/593,837, filed Oct. 27, 2023, entitled “Agricultural Implement Position Sensor and Related Devices, Systems, and Methods,” U.S. Patent Application 63/603,969, filed Nov. 29, 2023, entitled “Devices, Systems and Methods for Guidance Line Shifting,” U.S. Patent Application 63/607,227, filed Dec. 7, 2023, entitled “Header Height Control Devices, Systems and Methods,” U.S. Patent Application 63/609,758, filed Dec. 13, 2023, entitled “Magnetic Stripper/Deck Plate Sensing System,” U.S. Patent Application 63/646,038, filed May 13, 2024, entitled “Seed Tube Camera and Related Devices, Systems, and Methods,” U.S. Patent Application 63/626,744, filed Jan. 30, 2024, entitled “Grain Cart Unloading Sensor and Unload Control,” each of which is incorporated herein by reference.

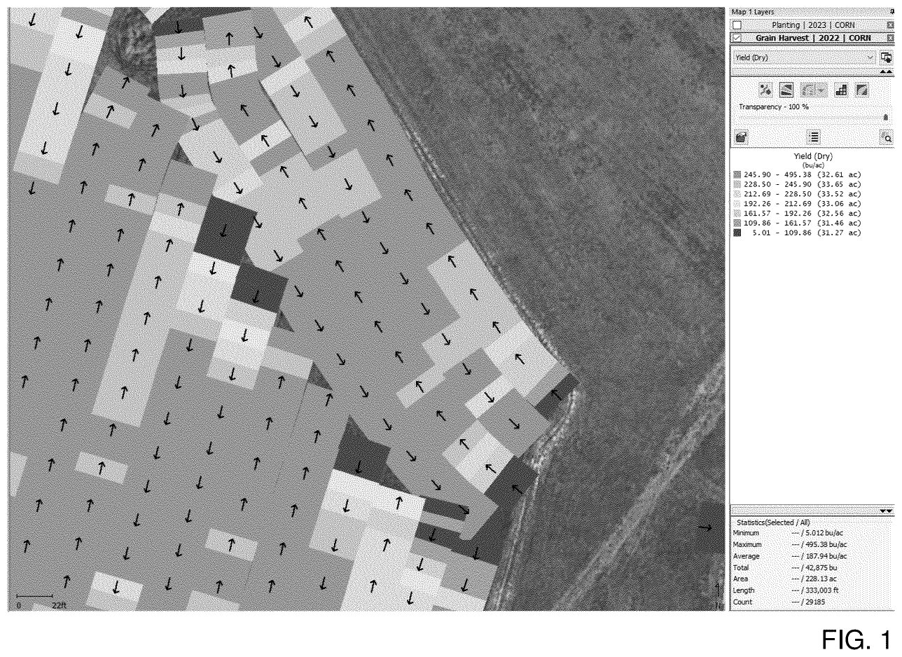

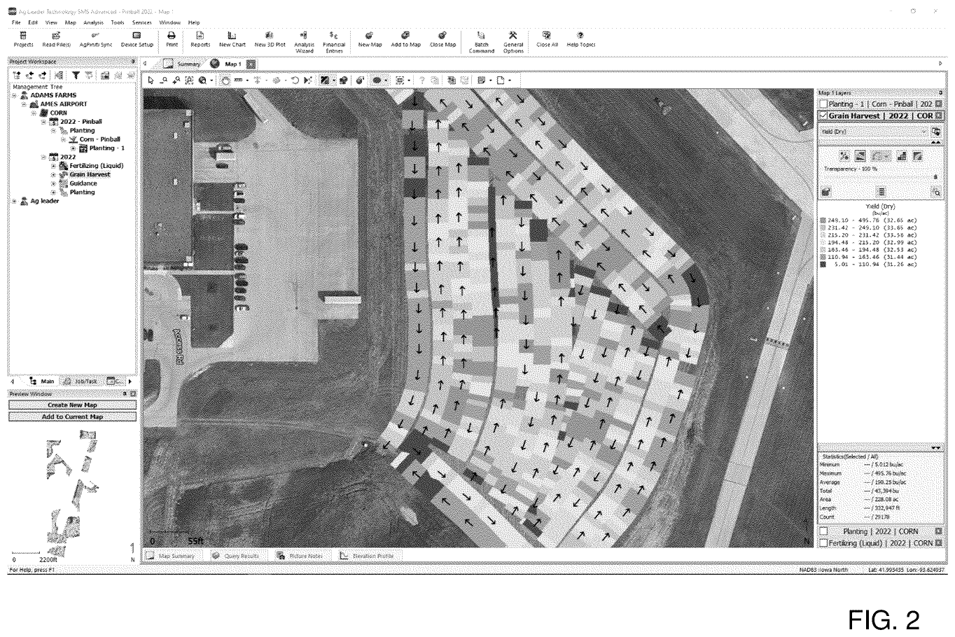

Various known harvest mapping systems use a time delay based on section control and predefined settings for matching grain flow with a point on the field. The disclosed system, methods, and devices allow for real time adjustment of that delay and better calculation of actual working width of the head. FIGS. 1 and 2 provide an example of data mapped with a non-optimized harvest delay. As can be seen, at the beginning of most passes there are areas where the yield is showing as zero where there was actually grain being harvested and as such should have displayed a non-zero value.

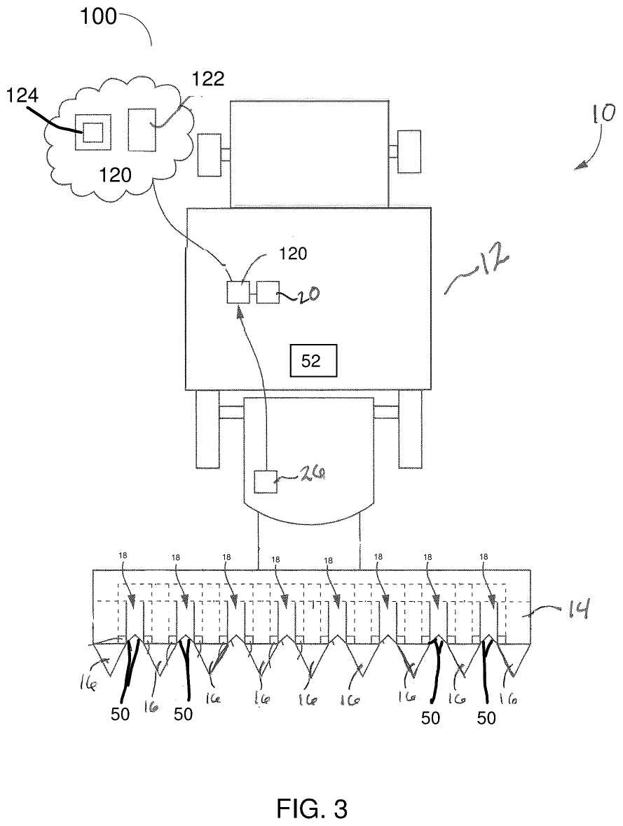

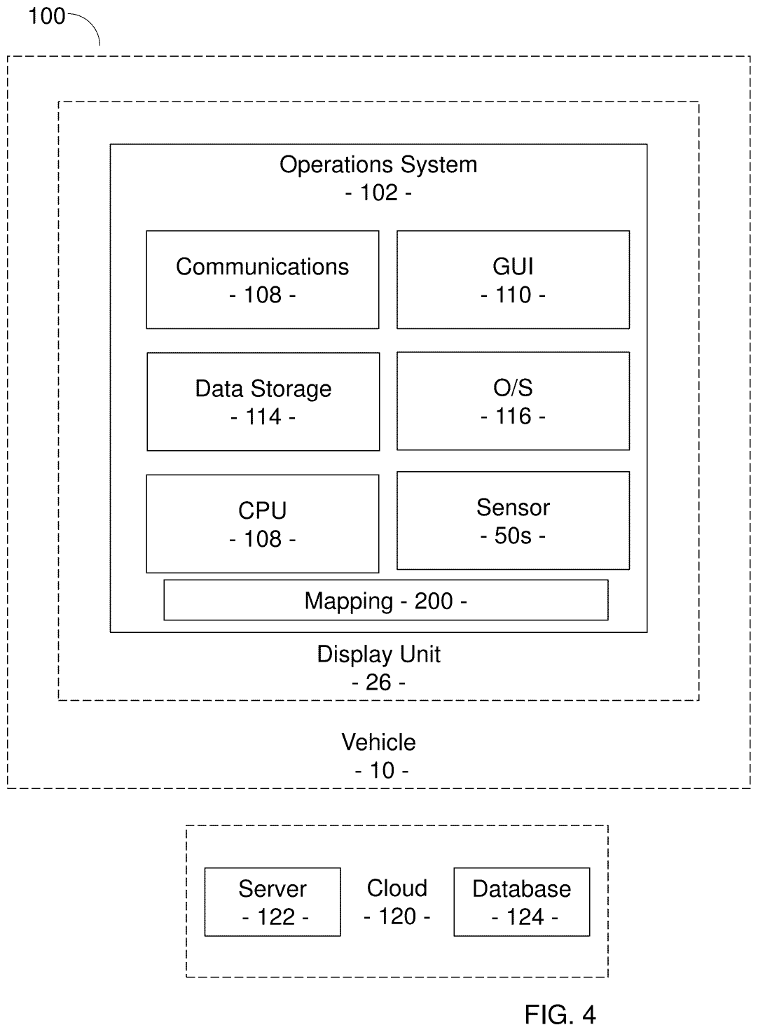

Turning to FIGS. 3 and 4 according to various implementations, system 100 can utilize any of the various sensing systems 50 and/or sensor assemblies 50 disclosed in the above incorporated references to obtain certain harvest data inputs, such as stalk count, stalk size, stalk circumference, stalk diameter, and the like as would be understood. In various implementations, the system 100 utilizes a contact, rotational stalk sensor 50 configured to measure the passage of each stalk and/or other stalk characteristics specific to the individual sensor type, as has been previously described in certain of the incorporated references. In any event, these sensor assemblies 50 mechanically engage (contact) or otherwise interact (non-contact) with passing plant stalks to detect and measure plant stalks on an individual plant and row-by-row basis, generating one or more harvest data inputs. In various implementations, at least one sensor 50 is present on each row unit 16 of a crop row harvesting head 14, although in various alternative implementations, a sensor 50 need not be on each row unit 16. Additionally or alternatively, the sensor 50 may be located on the edges of the head 14 and/or on the vehicle 10 body, as will be discussed further below.

As shown in FIGS. 3 and 4, the harvest data system 100 according to various implementations has an operations system 102 that is operationally integrated with the sensors 50 and several other optional components on the combine/harvester/vehicle 10 or elsewhere, such as a display 26. Various displays 26 are known to those of skill in the art, including in-cab displays 26, such as an InCommand® display from Ag Leader®. In various alternative implementations the display 26 is remote from the harvester 10 or other implement. It is appreciated that certain of these displays 26 feature touchscreens, while others are equipped with necessary components for interaction with the various prompts and adjustments discussed herein, such as via a keyboard, buttons, or other interface.

In various implementations, the system 100 is also operationally integrated with a GNSS or GPS unit 20, such as a GPS 7500, such that the system 100 is configured to input positional data for use in defining boundaries, locating the combine 10 for yield prediction, plotting guidance, and other purposes, as would be readily appreciated from the present disclosure and as discussed in the incorporated references.

Continuing with FIGS. 3 and 4, in various implementations, the operations system 102 is optionally in operational communication with a communications component 108. In certain implementations, the communications component 108 is configured for the sending and receiving of data for storage and processing, such as to the cloud 120, a remote server 122, database 124, and/or other cloud computing components readily understood in the art. Various implementations may also include storage on a remote drive/removable media such as a USB flash drive, CD-ROM, external hard drive, and the like. Such connections by the communications component 108 can be made via wired connections and/or wirelessly via understood internet and/or cellular technologies such as Bluetooth, Wi-Fi, LTE, 3G, 4G, or 5G connections and the like. It is understood that in certain implementations, the communications component 108 and/or cloud 120 component comprise encryption or other data privacy components, such as hardware, software, and/or firmware security aspects, as would be understood.

As shown in FIGS. 3 and 4, the operations system 102, according to certain implementations, has one or more optional processing and computing components, such as a CPU or processor 108, data storage 114, operating system (“O/S”) 116, and other computing components necessary for implementing the various technologies disclosed herein. It is appreciated that the various optional operations system 102 components are in operational communication with one another via wired or wireless connections and are configured to perform the processes and execute the commands described herein. As would be understood, each of these components can be located optionally at various locations around the vehicle 10 or elsewhere, such as in the cloud 120 and accessible by a wireless or cellular connection.

In various implementations, this connectivity means that an operator, enterprise manager, and/or other party is able to receive notifications such as adjustment prompts and confirmation screens on a mobile device or via another access point, such as a desktop, tablet, or secondary display. In certain implementations, these individuals can review the various data generated by the system 100 and make adjustments, comments, and/or observations in real-time, near real-time, or at subsequent times, as would be readily appreciated.

In certain implementations, the operations system 102 also includes or is operationally integrated with a steering component, such as an automatic or assisted steering component, such as SteerCommand® from Ag Leader®.

In certain of these implementations, the operations system 102 is housed in the display 104, and is operable by the user via, optionally, a graphical user interface (“GUI”) 110, though the various components described herein can be housed elsewhere, as would be readily appreciated. For example, the system 100 may utilize the cloud 120 and one or more cloud-based servers 122 and/or databases 124, as would be appreciated. In various implementations, the yield maps and data are displayed on-screen in the cab of the vehicle 10 and/or stored for viewing in a Farm Management Information Systems (FMIS), as would be appreciated.

It is further understood that the various components shown in FIGS. 3 and 4 are optional and can be present or omitted in the various claimed implementations, and that certain additional components may be required to effectuate the various processes and systems described herein.

Further, while various implementations of the disclosed harvest data system 100 are disclosed herein it would be understood by those of skill in the art that the disclosed harvest data system 100 consists of one or more steps and/or components each of which is optional and may be omitted entirely. Further, the various steps may be performed in any order or not at all, and the order of presentation of various steps and sub-steps does not imply that they may only be performed in any certain order.

In certain implementations, the system 100 gathers data by use of a contact sensor 50 (flexible member sensor or other impact sensor) and/or non-contact sensor 50 (camera, light gate, GPS approximation) on a crop harvester 10. Optionally, the contact or non-contact sensor 50 may detect, among other things, the start and end of a harvest pass including point rows. The detection of crop data via the contact or non-contact sensor may allow for adjustments the map delay and improvements to section mapping.

In various implementations, to prevent false readings from crop residue, the sensor 50 is used in conjunction with a mapping system 200 to determine already harvested areas. Optionally, the sensor 50 and system 100 are able to detect when the vehicle 10 is in an operational state, that is actively harvesting. For example, the vehicle 10 may be determined to be in an operational state when the head 14 is down and the thresher is at speed.

As would be appreciated, when first entering a pass, it is common to see low yields being mapped in relation to the surrounding area. This may be because of the delay between when the crop is registered by the flow sensor and the time taken to pass through the vehicle 10. An incorrect harvest delay may lead to mistakes during mapping. In various implementations, the crop sensing system 100 registers that the crop has started entering the head 14, then after some time crop would start registering on the flow sensor. That delay could then be accounted for and used by the system 100 to more accurately correlate yield to stalk/crop sensing points (by the sensor 50) and/or GPS points.

In various implementations, the system 100 can be configured to compare a previously mapped area to what was being sensed by the sensors 50 to tell how many rows are actually being harvested in a point row situation. For example, within the body of the field a missing row would not reduce the width being used to calculate yield because there is a possible agronomic reason the grower needs to be aware of. That is, in the middle of a swath a missing row may be due to lost yield, that is yield is expected and missing. But at an angled end of a row (point row) or in certain other appreciated situations no yield may be expected when a missing row is detected and as such should not be labeled as missing yield in the yield map.

Missing yield where there is an expectation of standing crop could be due to a number of factors that are important for future decision making and knowledge of operators and stake holders. Examples of factors for missing yield where there is an expectation of standing crop including, among others, seed meter jam, misapplication of pesticide and/or fertilizer, inadequate downforce, inadequate closing wheel pressure, excessive crop residue, compaction or knocking over of crop by other implements, pest damage, weed pressure, flood damage, nature disaster damage, and/or wind/hail/other weather damage.

By analyzing the number of rows actually being harvested, the system 100 may eliminate multiple characteristics that impact grain flow through the harvester 10. For example, different machinery manufacturers and models, travel speed, differences in crop characteristics and condition (hybrid and/or maturity), combine settings, operator differences, downed/damaged crop, and the like, may all contribute to the number of rows actually being harvested differing from the number of rows being used to calculate yield.

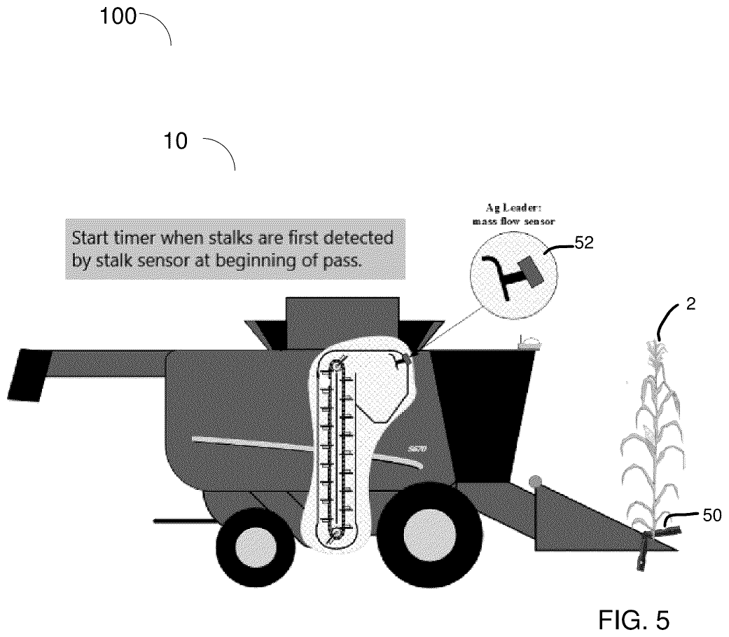

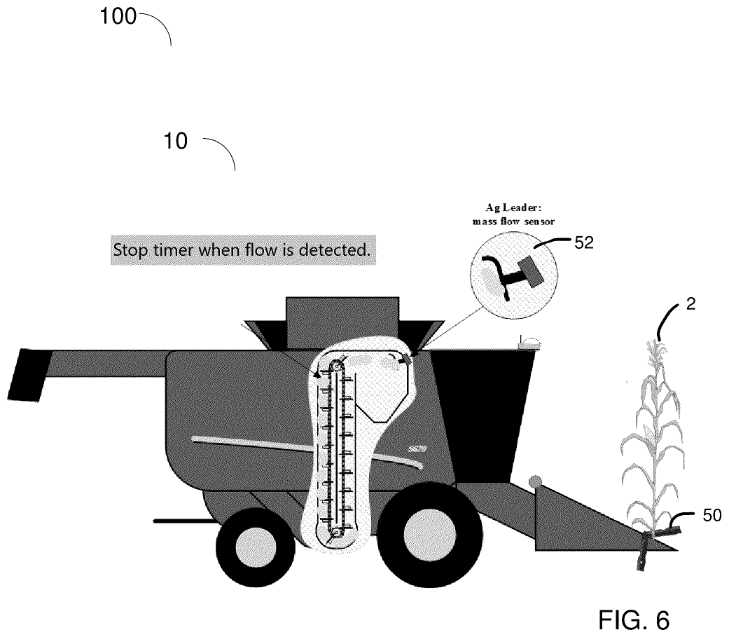

As shown in FIGS. 5 and 6, in various implementations, the harvest system 100 includes using the crop sensor 50 at the front of the combine 10 to start counting a time delay. Once the flow of grain 2 reaches the mass flow sensor 52 in the combine 10, the difference in time between sensing grain 2 at the crop sensor 50 and reaching the mass flow sensor 52 would be the new time delay. This delay could be calculated for each pass, or an average time delay could be calculated using multiple passes through the field, using the following equation:

$$Δ {T}_{Time Delay} = {T}_{Mass Flow Sensor} - {T}_{Stalk Sensor}$$

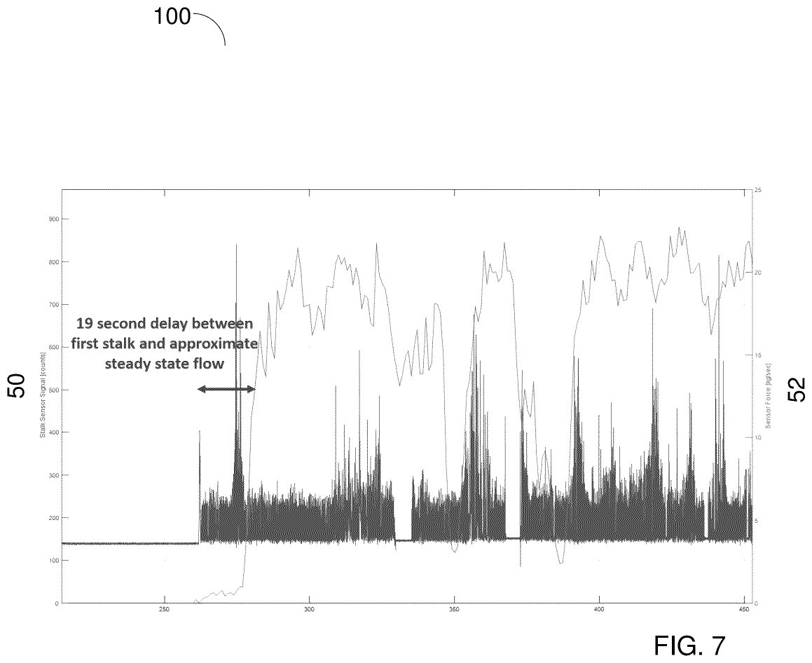

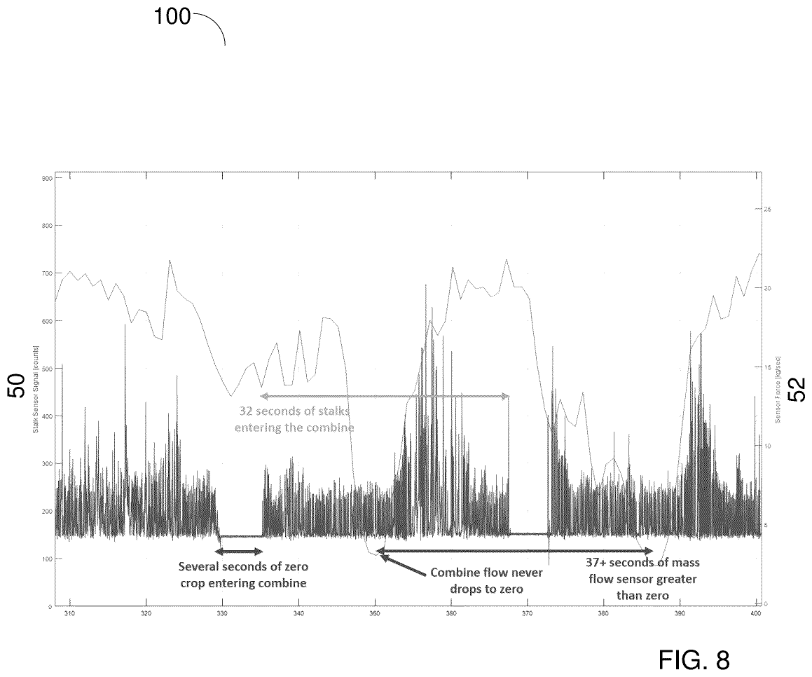

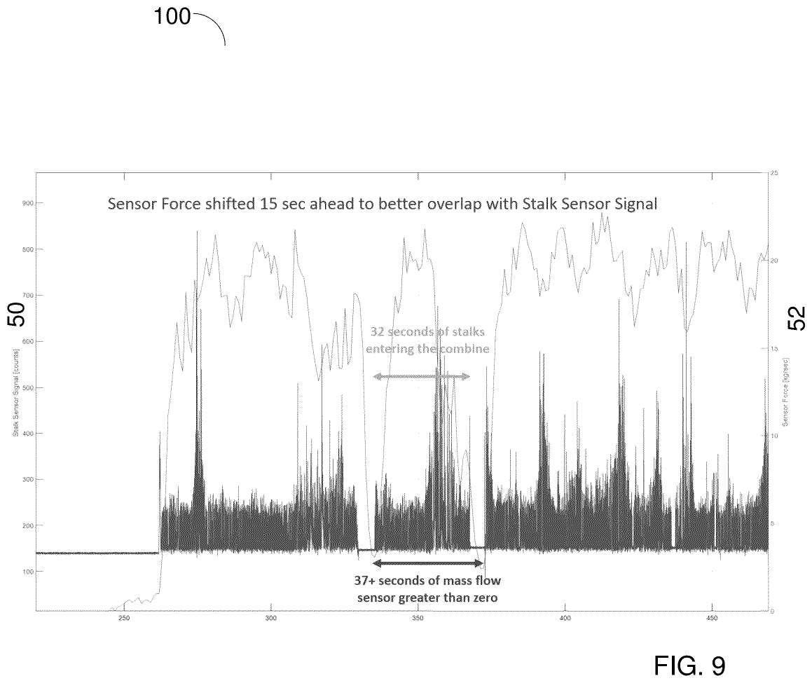

FIG. 7 demonstrates the time delay between the mass flow sensor 52 and the crop sensor 50. In this example a 19 second time delay is observed between the period where stalks 2 enter the corn head 14 and until grain reaches the mass flow sensor 52. As highlighted in FIG. 8, there are significant differences between the stalk sensor 50 signal and the mass flow sensor 52 signal. In this example, there is a distinct period of 32 seconds where material is entering the combine 10 at the stalk sensor 50, the corresponding region of data in the mass flow sensor 52 signal is observed to be at least 37 seconds (here the mass flow sensor 52 never reaches a period of 0 flow). In this example, an offset (harvest delay) of 15 seconds was applied, shown in FIG. 9, to visualize difference in data length between the two sensors 50, 52. That is, the system 100 is able to detect the harvest delay and adjust the data to reflect the reality of amount of crop harvested at the time/location of the crop entering the harvester at the sensor 50.

Various factors may drive the time difference between the amount of time the sensor(s) 50 detect crops entering the harvester and the amount of time the yield sensor 52 detects crop flow. One example being that stalks 2 entering the corn head 14 at the center of the machine enter the combine feederhouse almost immediately, while, the far outside rows are fed by an auger perpendicular to the feederhouse before they enter the combine 10. This results in a ramp up period where flow rate through the combine 10 gradually increases until it reaches a steady state, and crop from all rows is flow past the yield sensor 52.

A similar ramp down period is also possible where crop flow from outer rows continues after crop flow from the center rows has ended, as would be understood.

In another example, there is likely to be a smoothing out of flow as the grain is separated from the crop material and delivered to the mass flow sensor 52 through the combines 10 clean grain transportation system, as would be understood.

In another example, the length of the rows may not be equal, and as such the harvester 10 may see crop flow from one row or set of rows entering the machine several seconds before another row or set of row.

Knowing and mapping the exact range where stalks 2 are entering the harvester 10 provides necessary data to also improve the placement of mass flow sensor data 52 when it is being mapped. In some implementations, the system 100 identifies the ramp up and ramp down regions of the data and distributing those values to a subset of the data between the ramp up and ramp down regions of the mass flow sensor 52 data.

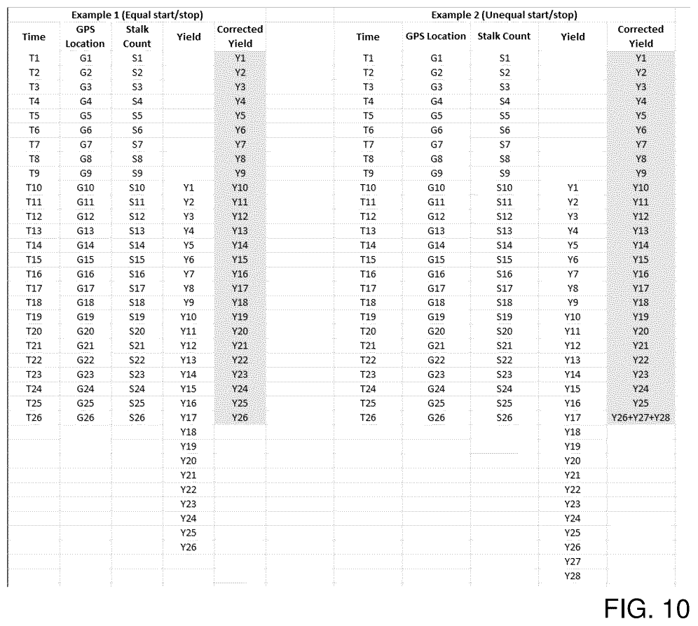

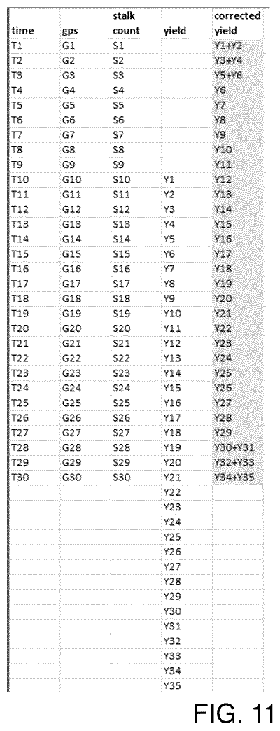

In some implementations, the system 100 is able to create a set of mass flow sensor 52 data that has an time offset applied and is equal in length to the period of time which the vehicle 10 was actually harvesting crop material. In various implementations, the data set might include the total mass flow sum, with data in the ramp up and ramp down periods distributed to a subset of the data, which is shown for example in FIGS. 10 and 11. This results in improved accuracy of yield maps displayed on-screen in the cab and logged data viewed in FMIS, as discussed above.

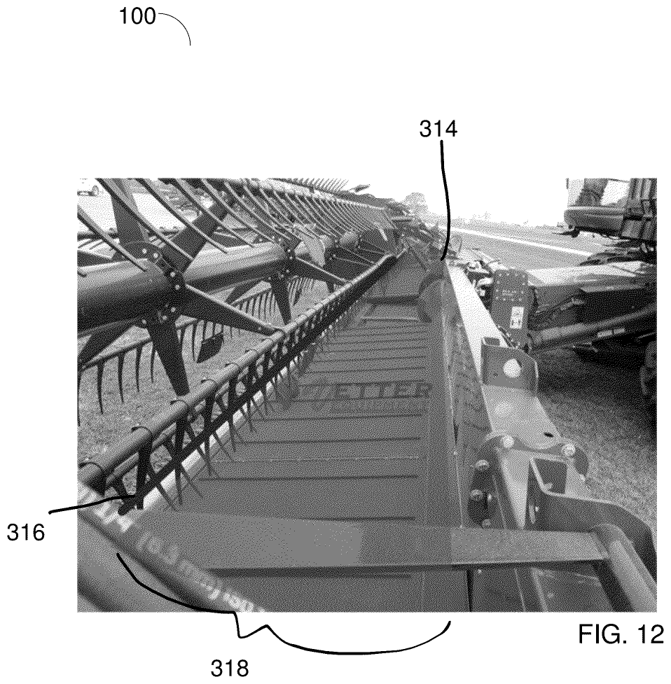

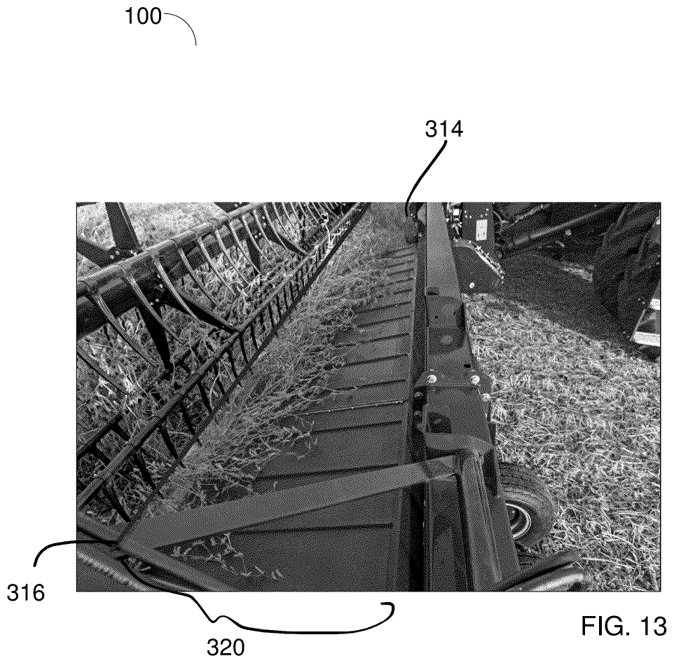

The system 100, in certain implementations, may use non-contact sensors 50, optionally for non-row crop grain heads. FIG. 12 shows and image of an empty draper head 314. In this example, the blue line 316 indicates the cutting edge and the red transparent area 318 indicates no crop entering the head 314 and 0% working width. FIG. 13 shows soybeans entering the draper head 314. The blue line 316 indicates the cutting edge and the green transparent area 320 would indicate crop is entering the head 314 and it is at 100% working width. In this example, a sensor 50, such as LIDAR, light gates, radar, sonar, camera with image recognition/machine vision, or other non-contact sensor, may be mounted on the head 314 or vehicle 10 to detect when crop enters the head 314 and calculate active working width.

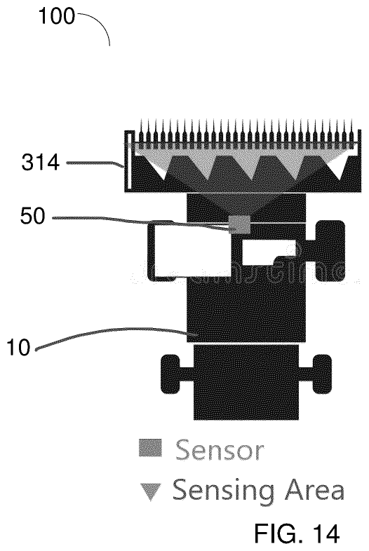

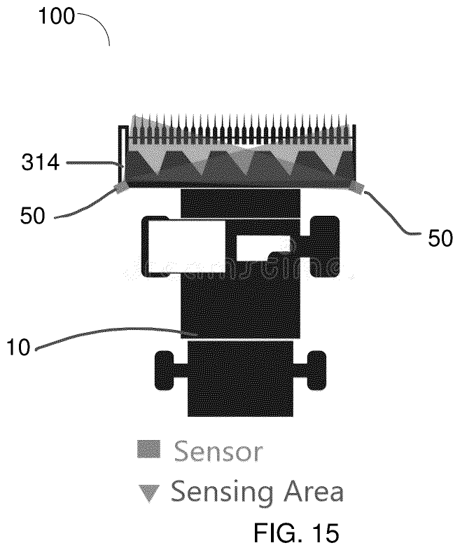

The sensors 50 could be mounted on the combine (FIG. 14) or head (FIG. 15) to detect crop as it is being cut and enters the auger/draper 314 and when crop is no longer being cut. These sensors 50 may also be configured to determine the active working width by determining how much of the cutting edge is covered by crop.

Although the disclosure has been described with references to various embodiments, persons skilled in the art will recognize that changes may be made in form and detail without departing from the spirit and scope of this disclosure.

What is claimed is:

1. A method for mapping yield in real time or near real-time comprising:
(a) determining when crop enters a harvester head via one or more sensors;
(b) determining when the crop reaches a yield sensor; and
(c) measuring the time delay between the crop entering the harvester head and when the crop reaches a yield sensor.

2. The method of claim 1, further comprising adjusting the yield data to account for the time delay.

3. The method of claim 1, further comprising geographically shifting recorded yield values to recorded stalk locations from the one or more sensors based on the time delay.

4. The method of claim 1, further comprising measuring a time delay for each pass.

5. The method of claim 1, further comprising display time delay adjusted yield maps to an operator on a display.

6. The method of claim 1, wherein the one or more sensors are contact sensors.

7. The method of claim 1, wherein the one or more sensors are non-contact sensors.

8. The method of claim 1, further comprising mapping harvested rows and eliminating reading from the one or more sensors of already harvested rows.

9. The method of claim 1, further comprising determining an actual number of rows being harvested by signals from the one or more sensors and adjusting yield data to come from the actual number of rows being harvested.

10. The method of claim 1, further comprising determining ramp up and ramp down periods at the yield monitor and adjusting the yield data to account for ramp up and ramp down periods.

11. An agricultural harvesting system, comprising:
(a) at least one sensor disposed on a harvester head configured to detect when crop enter the harvester head;
(b) a yield sensor disposed on the harvester configured to measure crop flow;
(c) a storage device in communication with the at least one sensor configured to receive signals from the at least one stalk sensor and the yield sensor; and
(d) a processor in communication with the at least one storage device configured to processes the signals from the at least one sensor and the yield sensor to determine a harvest delay between when crop is detecting entering the harvester head and when the yield sensor detects crop flow and adjust data from the signals from the at least one sensor and the yield sensor.

12. The system of claim 11, further comprising a display in communication with the storage device and the processor configured to display harvest delay adjusted yield maps to an operator in real time or near real-time.

13. The system of claim 11, further comprising a GNSS device configured to determine geographic locations for data from the at least one sensor and the yield sensor, and wherein the processor is further configured to geographically adjust the data from the signals from the at least one sensor and the yield sensor.

14. The system of claim 11, wherein the harvest delay is calculated for each harvest pass.

15. The system of claim 11, wherein the harvester head is a row crop harvester.

16. The system of claim 11, wherein the harvester head is a draper head.

17. The system of claim 16, wherein the harvest delay is the time between then the at least one sensor detects crop entering the draper head at a cutting edge and the time when crop flow is detected by the yield sensor.

18. The system of claim 11, wherein the at least one sensor is further configured to determine a work width of the draper head.

19. The system of claim 11, wherein the at least one sensor is a non-contact sensor.

20. The system of claim 11, wherein the at least one sensor is a contact sensor.
